(19) United States
(12) Patent Application Publication
(10) Pub. No.: US 2019/0256419 A1
(43) Pub. Date: Aug. 22, 2019

(54) REINFORCEMENT FIBER HAVING MULTIPLE LINEAR GROOVES, AND MORTAR AND ASCON HAVING SAME REINFORCEMENT FIBER MIXED THEREIN

(71) Applicant: Iilho CHOI, Wanju-gun (KR)

(72) Inventor: Iilho CHOI, Wanju-gun (KR)

(21) Appl. No.: 16/094,862

(22) PCT Filed: Mar. 10, 2017
(86) PCT No.: PCT/KR2017/002612

§ 371 Date: Oct. 18, 2018

(30) Foreign Application Priority Data
Apr. 19, 2016 (KR) 10-2016-0047473

(51) Int. Cl. C04B 20/00

(52) U.S. Cl. CPC C04B 20/0048; C04B 16/12

(57) ABSTRACT

The present invention relates to a reinforcement fiber (100) for strengthening a mortar. The reinforcement fiber (100) comprises: a cylindrical fiber body (10); and multiple linear grooves (20) formed on an outer surface of the fiber body (10), wherein the multiple linear grooves (20) comprise: multiple straight linear grooves (30) formed along the longitudinal direction on a surface of the fiber body (10); and an annular linear groove (40) surrounding the fiber body (10) while intersecting the multiple straight linear grooves (30), the straight linear grooves (30) are radially formed with reference to the center of the fiber body (10), and the straight linear grooves (30) and the annular linear groove (40) have a plurality of micro linear grooves (310) formed therein.

The present invention relates to a reinforcement fiber having a plurality of linear grooves, and mortar and ascon (asphalt concrete) having the same reinforcement fiber mixed therein and more specifically, to a method for reinforcing a structure by mixing a reinforcement fiber having a plurality of linear grooves, thereby making it possible to reduce the amount of material for the structure and lighten the structure.

### DESCRIPTION OF THE RELATED ART

With the advancement of construction technologies, various sorts of construction materials have been developed and used. One of the materials is mortar.

As is well known, mortar is a mixture where cement, fine aggregate and water are mixed. Research into mortar has been underway to improve the properties of mortar. Thus, mortar where in addition to cement, fine aggregate, sand, various admixtures such as fly ash, a high range water reducer etc. are mixed has been developed. In recent years, fiber-reinforced mortar, which contains short staple fibers for reinforcement with high tensile strength so as to increase the tensile strength of mortar in addition to cement, fine aggregate, water and various sorts of admixtures that have been described above, has been developed and used.

Concrete structures in which such mortar is used have been widely used for civil engineering and construction.

A variety of patent documents including patent documents 1 and 2 disclose such fiber-reinforced mortar. Specifically, patent document 1 discloses fiber-reinforced building materials which include a mixture containing an inorganic binder and oily material, whose fibrous material is characterized by a low initial aspect ratio and is characterized by an initial surface area of 200 or less mm², and in which fibrillation is gradually performed while the mixture agitates, thereby leading to a 20% increase in the surface area on average.

Patent document 2 discloses a method for manufacturing bricks for interior materials, which includes mixing a hardener of fiber-reinforced plastic and silica flour-sludge-mixed liquor at a weight ratio of 1:1 or 5:1 and generating a composition, adding 5 to 20 parts by weight of fireproof styrofoam grains to 80 to 95 parts by weight of the generated composition and generating a mixture, agitating the generated mixture at ordinary temperature or at 50° C. for 1 to 2 hours, and filling a brick mold with the agitated mixture and hardening the same.

Various sorts of reinforcement fibers have been used for traditional fiber-reinforced construction materials and in the method for manufacturing the same. Such reinforcement fibers have the advantage of helping increase the strength of concrete structures, lighten the structures and reduce the size of the structures.

However, fibers used for traditional fiber-reinforced structures are configured to be linear, and when part of a concrete structure has cracks, reinforcement fibers escape from the concrete and a part with a crack falls off. Meanwhile, fibers may be also used for ascon in addition to cement, mortar to increase the strength of the ascon. However, the ascon does not have enough tensile strength or flexibility to withstand a shock applied to the ascon.

(Patent Document 0001) South Korean Patent Laid-Open Publication No. 10-2001-0034589

(Patent Document 0002) South Korean Patent No. 1468948

### DETAILED DESCRIPTION OF THE INVENTION

### Technical Problems

As a means to solve the above-described problems, the present invention is directed to providing mortar mixed with a reinforcement fiber which has a plurality of linear grooves, thereby making it possible to increase strength, manufacture more solid structures, reduce the amount of material used for the structure and lighten the structure.

### Technical Solutions

A reinforcement fiber 100, laid in mortar and reinforcing the mortar, according to one aspect of the present invention includes a cylindrical fiber body 10, and a plurality of linear grooves 20 formed on an outer surface of the fiber body 10, wherein the plurality of linear grooves 20 include a plurality of straight linear grooves 30 formed on a surface of the fiber body 10 in a longitudinal direction thereof, and annular linear grooves 40 surrounding the fiber body 10 to intersect the plurality of straight linear grooves 30, the straight linear grooves 30 are radially formed with reference to the center of the fiber body 10, and the straight linear grooves 30 and the annular linear grooves 40 have a plurality of micro linear grooves 310 formed therein. The micro linear grooves 310 may be formed throughout an outer surface of the fiber body 10.

The plurality of micro linear grooves 310 include first micro linear groves 311 formed on bottoms thereof and second micro linear grooves 315 arranged to face each other on lateral surfaces thereof.

Micro grooves 320 or micro protrusions 330 may be formed throughout the outer surface of the fiber body 10. The micro grooves 320 or micro protrusions 330 have the shape of a hemisphere or a circular column.

The reinforcement fiber 100 consists of any one of a fiber group including metallic fibers, polyurethane fibers, plastic fibers, nylon fibers, rubber fibers, aramid fibers. Additionally, reinforcement fiber-reinforced mortar and ascon are made of any one of the group including metallic fibers, polyurethane fibers, plastic fibers, nylon fibers, rubber fibers, aramid fibers or a combination thereof.

According to another aspect of the present invention, 1 to 50 wt % of yellow clay is mixed with respect to the entire weight of mortar or ascon mixed with a reinforcement fiber.

0.01 to 20 wt % of a reinforcement fiber is mixed with respect to an entire weight.

### Advantageous Effects

A reinforcement fiber according to the present invention, as described above, is provided with linear grooves so as to increase a bond thereof with mortar or ascon.

Further, the strength of structures or bricks using reinforcement fibers is increased through the reinforcement fibers thereby making it possible to reduce the amount of materials used for manufacture, reduce manufacturing costs, lighten products and minimize the size thereof.

### BRIEF DESCRIPTION OF THE DRAWINGS

FIG. 1 is a perspective view of a reinforcement fiber according to an embodiment of the present invention.

FIG. 2 is a perspective view of a reinforcement fiber according to another embodiment of the present invention.

FIG. 3 is a perspective view of a reinforcement fiber according to another embodiment of the present invention.

FIG. 4 is a perspective view of a reinforcement fiber according to yet another embodiment of the present invention.

### MODE FOR CARRYING OUT THE INVENTION

Preferred embodiments according to the present invention will be described in detail with reference to the attached drawings.

Description of specific structures or functions that will be described below is intended to describe embodiments according to the concept of the present invention. The present invention may be embodied in different forms, and should not be construed as being limited to the embodiments set forth herein.

Further, as embodiments according to the concept of the present invention may be modified in various forms, specific embodiments will be illustrated in the attached drawing and described in detail in this specification. However, it is to be understood that embodiments according to the concept of the present invention are not limited to specific ones and are intended to cover various modifications, equivalents and alternatives within the technical spirit and technical scope of the present invention.

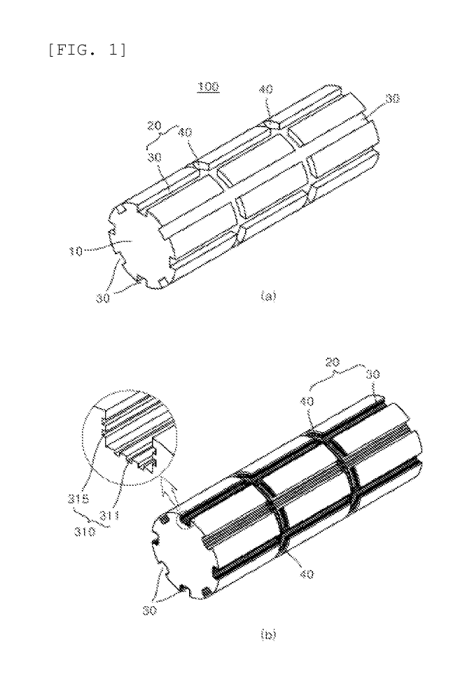

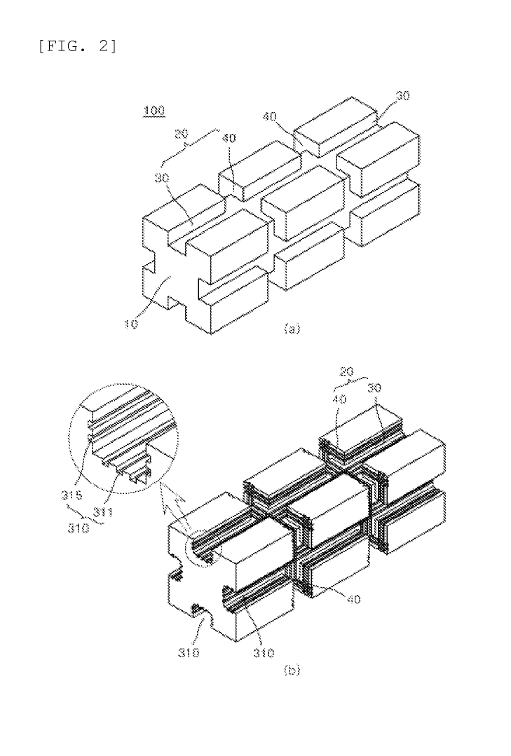

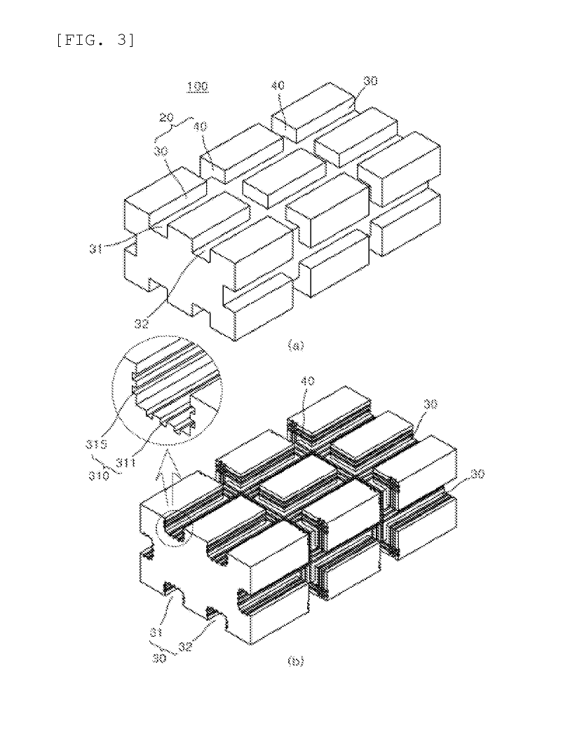

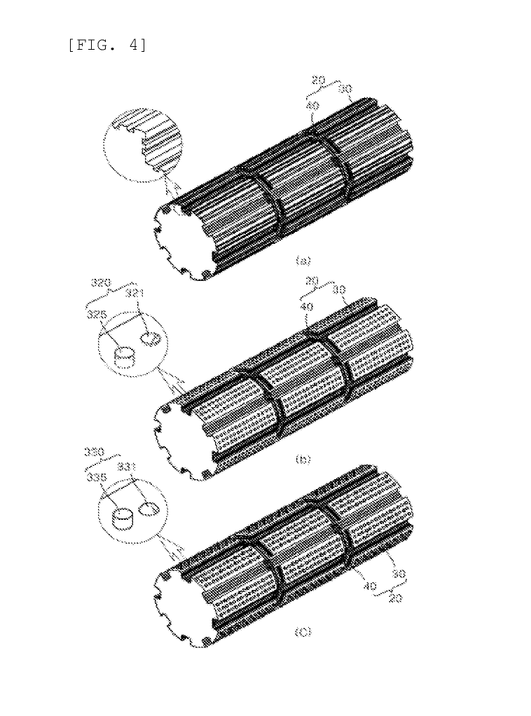

FIG. 1 is a perspective view of a reinforcement fiber according to an embodiment of the present invention, FIG. 2 is a perspective view of a reinforcement fiber according to another embodiment of the present invention, FIG. 3 is a perspective view of a reinforcement fiber according to another embodiment of the present invention, and FIG. 4 is a perspective view of a reinforcement fiber according to yet another embodiment of the present invention.

The present invention aims to reinforce a bond between a reinforcement fiber, and mortar or asphalt concrete (ascon). According to the present invention, a plurality of linear grooves 20 are formed on a reinforcement fiber 100.

That is, a reinforcement fiber 100 according to the present invention, as illustrated in FIGS. 1 to 4, includes a plurality of linear grooves 20 formed a surface thereof, and the plurality of linear grooves 20 are filled with mortar or ascon etc. so as to reinforce a bond between the reinforcement fiber and concrete.

With reference to FIG. 1, a reinforcement fiber 100 according to an embodiment of the present invention includes a cylindrical fiber body 10 and a plurality of linear grooves 20 formed on an outer surface of the fiber body 10.

With reference to FIG. 1a, the plurality of linear grooves 20 include straight linear grooves 30 formed on a surface of the fiber body 10 in a longitudinal direction thereof and annular linear grooves 40 formed on the surface of the fiber body 10 along a circumference thereof. The straight linear grooves 30 are regularly spaced apart from each other along the circumference of the fiber body 10, and may be formed radially with respect to the center of the fiber body 10. Meanwhile, the annular linear grooves 40 are configured to intersect the plurality of straight linear grooves 30 on the fiber body 10. Two or more annular linear grooves 40 may be arranged on the fiber body 10 with respect to the entire length thereof.

With reference to FIG. 1b, micro linear grooves 310 are formed on the plurality of linear grooves 20.

Specifically, the straight linear grooves 30, for instance, may have a rectangular cross section and include a plurality of micro linear grooves 310 on inner surfaces thereof. The plurality of micro linear grooves 310 include first micro linear groves 311 formed on bottoms thereof and second micro linear grooves 315 formed to face each other on lateral surfaces of thereof.

Meanwhile, the annular linear grooves 40 also include micro linear grooves formed thereon, which are similar to those formed on the straight linear grooves 30.

Micro linear grooves may be formed on inner surfaces of the straight linear grooves 30 and annular linear grooves 40. However, in some cases, micro linear grooves may be formed on the outer surface of the fiber body 10.

Meanwhile, in order to improve efficiency in production, annular linear grooves 40 and micro linear grooves 310 formed inside the annular linear grooves may be excluded when fibers are manufactured.

Further, a plurality of protrusions may be formed on the fiber body 10 in addition to the plurality of linear grooves 20. That is, a reinforcement fiber 100 basically includes a plurality of linear grooves formed on the outer surface of a fiber body 10 in the longitudinal direction thereof along the circumference thereof, micro linear grooves formed on the linear grooves, and a plurality of protrusions formed on the outer surface of the fiber body 10 so as to reinforce a bond between a reinforcement fiber and mortar or ascon.

With reference to FIG. 2, a reinforcement fiber 100 according to another embodiment of the present invention includes a rectangular column-shaped fiber body 10 and a plurality of linear grooves 20 formed on outer surfaces of the fiber body 10.

With reference FIG. 2a, the plurality of linear grooves 20 include straight linear grooves 30 formed on surfaces of the fiber body 10 in a longitudinal direction thereof and annular linear grooves 40 formed on the surfaces of the fiber body 10 along a perimeter thereof so as to intersect the straight linear grooves 30. The straight linear grooves 30 may be respectively arranged on each surface of the rectangular column-shaped fiber body 10.

The straight linear grooves 30 are regularly spaced apart from each other on flat planes perpendicular to an axial direction along the perimeter of the fiber body 10, and as a whole, may be formed radially around the center of the fiber body 10. Meanwhile, the annular linear grooves 40 are configured to intersect the plurality of straight linear grooves 30 on the fiber body 10. Two or more annular linear grooves 40 may be arranged on the fiber body 10 with respect to the entire length thereof.

With reference to FIG. 2b, micro linear grooves 310 are formed on the plurality of linear grooves 20.

The structure and shape of the arrangement of the micro linear grooves are identical with those described with reference to FIG. 1 and thus will be omitted.

With reference to FIG. 3, a reinforcement fiber 100 according to another embodiment of the present invention includes a rectangular column-shaped fiber body 10 and a plurality of linear grooves 20 formed on outer surfaces of the fiber body 10.

With reference FIG. 3a, the plurality of linear grooves 20 include straight linear grooves 30 formed on surfaces of the fiber body 10 in a longitudinal direction thereof and annular linear grooves 40 formed on the surfaces of the fiber body 10 along a perimeter thereof so as to intersect the straight linear grooves 30.

Meanwhile, two straight linear grooves 30 may be arranged respectively on one pair of surfaces, facing each other, of the rectangular column-shaped fiber body 10, and one straight linear groove may be arranged respectively on the other pair of surfaces, facing each other, of the rectangular column-shaped fiber body 10.

The structure and shape of the arrangement of micro linear grooves are identical with those described with reference to FIG. 1 and thus will be omitted.

With reference to FIG. 4, a reinforcement fiber 100 according to yet another embodiment of the present invention includes at least one of the micro linear groove 310, micro groove 320 and micro protrusion 330 on an outer surface of the fiber body 10.

With reference to FIG. 4a, micro linear grooves 310 are formed on the outer surface of the fiber body 10 as a whole. That is, micro linear grooves 310 are formed on the outer surface of the fiber body 10 as a whole in addition to a plurality of linear grooves 20.

With reference to FIG. 4b, micro grooves 320 are formed on the outer surface of the fiber body 10 as a whole. The micro grooves 320 may have the shape of a hemisphere 321 or a circular column 325. That is, micro linear grooves 310 may be formed on the plurality of linear grooves 20 while micro grooves 320 may be formed on the outer surface of the fiber body 10.

With reference to FIG. 4c, micro protrusions 330 are formed on the outer surface of the fiber body 10 as a whole. The micro protrusions 330 may have the shape of a hemisphere 331 or a circular column 335. That is, micro linear grooves 310 may be formed on a plurality of linear grooves 20 while micro protrusions 330 may be formed on the outer surface of the fiber body 10.

The micro linear grooves 310, micro grooves 320 and micro protrusions 330 may be formed on the outer surface of the fiber body 10 selectively or as a whole.

A reinforcement fiber 100 of the present invention is buried in a structure and reinforces a bond between ascon and ascon or between mortar and mortar when plastic working is performed to ascon or mortar. As a result of increasing a structural strength, the size of a structure may be reduced, and a hollow part may be formed in the structure such that a space occupied by a material may be reduced.

The reinforcement fiber may consist of various sorts of fibers and preferably, any one of a fiber group including metallic fibers, polyurethane fibers, plastic fibers, nylon fibers, rubber fibers, aramid fibers. Additionally, reinforcement fiber-reinforced mortar and ascon are made of any one of the group including metallic fibers, polyurethane fibers, plastic fibers, nylon fibers, rubber fibers, aramid fibers or a combination thereof.

Preferably, the reinforcement fiber 100 ranges from 1 mm to 30 mm in diameter, thickness, or width, and ranges from 2 cm to 30 cm in length. Preferably, the largest diameter of the annular linear groove ranges from 0.3 mm to 10 mm, the diameter of the micro linear groove ranges from 5 μm to 500 μm, and the diameter and height of the groove and protrusion range from 5 μm to 500 μm.

As described above, a reinforcement fiber according to the present invention is used to increase a structural strength and used for roads, the bottoms or pillars of building or civil structures, or masonry blocks.

The reinforcement fiber 100 may be mixed, tangled, or overlapped with mortar so as to increase a bond between cement and cement or aggregate and aggregate.

With such a reinforcement fiber 100, mortar may have a higher strength than existing mortar. Thus, the size of blocks where mortar is configured to have a predetermined shape may be reduced, or hollow parts may be formed inside blocks so as to lighten the blocks even in the case where the blocks have the same volume.

The hollow parts may block sound from entering or leaving and block heat from leaving.

In the case of a structure where mortar is solidified, a reinforcement fiber 100 preferably accounts for 0.01 to 20 wt % of the entire weight of the structure.

When there is a large amount of reinforcement fiber, mortar does not fill a space between the reinforcement fibers, thereby lowering tensile strength. Further, when there are a small number of reinforcement fibers, reinforcement is not well performed. Thus, preferably, the reinforcement fibers accounts for 0.01 to 20 wt %of the entire weight of the structure.

In the case of a structure that is made in the above-described mode, 1 to 50 wt %of yellow clay with respect to the entire weight of the structure may be further mixed.

Users may benefit from yellow clay that may control humidity and radiate far infrared rays. A reinforcement fiber-reinforced structure is another example where a reinforcement fiber of the present invention is used.

The structure may include roads or the bottoms or pillars of buildings, etc., as described above.

To make such a reinforced structure, a reinforcement fiber mixed with mortar or ascon is molded, and plastic work is performed to the mixture. Preferably the reinforcement fiber accounts for 0.01 to 20 wt %of the entire weight of the mortar or ascon.

The strength of roads, or the bottoms or pillars of buildings are preferably increased with a large amount of reinforcement fiber, while the strength of blocks are increased with plastering mortar added to the blocks after the masonry of the blocks. This is because roads, or the bottoms or pillars of buildings are not finished with plastering mortar.

Further, in the case of a reinforced structure including roads, or the bottoms or pillars of buildings, the ratio is limited as described above according to the sort of reinforcement fiber and the use of the reinforced structure. A weight ratio may decrease when only light fiber is used while a weight ratio may increase when heavy metallic fiber is used.

In the case of a reinforced structure that is made in the above-described mode, 1 to 50 wt %of yellow clay with respect to the entire weight of the reinforced structure may be further mixed.

Meanwhile, according to the present invention, the reinforcement fiber 100 may include reinforcement protrusions in addition to linear grooves 20. Specifically, metallic fibers or plastic fibers may be formed as a protrusion in the process of manufacture.

In order to manufacture a reinforcement protrusion, a fiber may be knotted once or more times. That is, a long fiber 100 may be knotted once or more times so as to form reinforcement protrusions on the fiber. In this case, the knots are laid in a material for structure such as ascon or mortar so as to increase a bond between the fiber 100 and ascon or mortar.

Preferably, the reinforcement fiber 100 ranges from 1 mm to 30 mm in diameter, thickness, or width, and ranges from 2 cm to 30 cm in length. Preferably, the largest diameter of the annular linear groove ranges from 0.3 mm to 10 mm, the diameter of the micro linear groove ranges from 5 μm to 500 μm, and the diameter and height of the groove and protrusion range from 5 μm to 500 μm.

10: Fiber body

20: Linear groove

30: Straight linear groove

40: Annular linear groove

100: Reinforcement fiber

310: Micro linear groove

320: Micro groove

330: Micro protrusion

1. A reinforcement fiber (100), laid in mortar and reinforcing the mortar, comprises a cylindrical or polygonal column shaped-fiber body (10), and a plurality of linear grooves (20) formed on an outer surface of the fiber body (10),
wherein the plurality of linear grooves (20) comprise a plurality of straight linear grooves (30) formed on a surface of the fiber body (10) in a longitudinal direction thereof, and annular linear grooves (40) surrounding the fiber body (10) to intersect the plurality of straight linear grooves (30),
wherein at least one of a micro linear groove (310), a micro groove (320) and a micro protrusion (330) may be formed in multiple numbers on the outer surface of the fiber body (10).

2. The reinforcement fiber according to claim 1, wherein the plurality of straight linear grooves (30) are radially formed with respect to the center of the fiber body (10).

3. The reinforcement fiber according to claim 1, wherein the plurality of micro linear grooves (310) are radially formed with respect to the center of the fiber body (10).

4. The reinforcement fiber according to any one of claims 1, 2 and 3, are made of any one of metallic fiber, plastic fiber, rubber fiber, or a combination thereof.

5. Mortar mixed with the reinforcement fiber according to claim 4.

6. Ascon mixed with the reinforcement fiber according to claim 4.
